(19) United States
(12) Patent Application Publication
(10) Pub. No.: US 2026/0319438 A1
(43) Pub. Date: Oct. 15, 2026

(54) ACTUATING MECHANISM FOR A FLEXIBLE DISPLAY HAND DRIVEN BY A HOROLOGICAL MOVEMENT

(71) Applicant: Montres Breguet S.A., L'Abbaye (CH)

(72) Inventors: Lionel MATTHEY-DE-L'ENDROIT, St-Livres (CH); Marc STRANCZL, Nyon (CH)

(73) Assignee: Montres Breguet S.A., L'Abbaye (CH)

(21) Appl. No.: 19/106,487

(22) PCT Filed: Sep. 7, 2023
(86) PCT No.: PCT/EP2023/074609

§ 371 Date: Feb. 25, 2025

(30) Foreign Application Priority Data
Sep. 8, 2022 (EP) 22194562.9

(51) Int. Cl. G04B 19/02

(52) U.S. Cl. CPC G04B 19/02

(57) ABSTRACT

A mechanism for actuating a flexible display hand (20), intended to be driven by a horological movement of a watch, the flexible display hand (20) comprising a first and a second drive pipe (16, 18) arranged coaxially about an axis of rotation D1. The actuating mechanism includes a first differential mechanism (2) having a first input to receive an angular rotation of angle (θ1), transmitted by the horological movement and determining the rotation of the flexible display hand (20), and an output of the first differential mechanism (2) to drive the flexible display hand (20) rotatably. A second differential mechanism (4) has first input connected to the first input of the first differential mechanism, a second input to receive an angular rotation (θ2) determining a change in the length of the flexible display hand (20), and an output to control the change in length of the flexible display hand.

### TECHNICAL FIELD OF THE INVENTION

The present invention relates to an actuating mechanism for a flexible display hand driven by a horological movement of a watch.

### TECHNOLOGICAL BACKGROUND

In the recent past, the Applicant has already disclosed a number of actuating mechanisms for flexible display hands. Such actuating mechanisms are arranged to rotate a flexible display hand about itself while controlling its change in shape and length in order to display time or other information in an original way.

However, the development of such actuating mechanisms requires fairly complex computations in order to obtain the desired result in terms of speed of rotation and change of shape of the flexible display hand. Another drawback of these actuating mechanisms is that the trajectory of the flexible hand is fixed: in other words, the length of the hand is linked to its position.

### SUMMARY OF THE INVENTION

The present invention aims to satisfy the above and other needs by providing a mechanism for actuating a flexible display hand allowing the movement of a flexible display hand and its changes in shape and length to be defined independently of each other.

To this end, the present invention relates to a mechanism for actuating a flexible display hand driven by a horological movement, the flexible display hand comprising a first drive pipe connected to a first end of a first flexible arm, and a second drive pipe connected to a first end of a second flexible arm, the first and second flexible arms being connected together at their second end by a tip, the first and second drive pipes being spaced apart when the flexible display hand is in an unstressed, free state.

The flexible display hand is arranged in an operating position in which it has a defined shape and length and is in a stressed state, with the first drive pipe and the second drive pipe being arranged coaxially about an axis of rotation. The first drive pipe is mounted at a defined first prestressing angle, and the second drive pipe is mounted at a defined second prestressing angle in the opposite direction to that of the first drive pipe.

The actuating mechanism is arranged to drive the flexible display hand rotatably and control its change in length, the first differential mechanism comprising a first input to which the horological movement applies an angular rotation which determines the rotation of the flexible display hand about itself, this angular rotation also being applied with a gear ratio to a first input of the second differential mechanism, a phase-shifting angular rotation which determines a change in length of the flexible display hand being applied to a second input of the second differential mechanism, an output of the second differential mechanism which controls the change in length of the flexible display hand being applied to a second input of the first differential mechanism, an output of the first differential mechanism driving the flexible display hand rotatably and controlling its change in length.

Thanks to these features, the present invention provides an actuating mechanism for a flexible display hand, including mechanisms for driving it rotatably, as well as for controlling its change in length. As these mechanisms are of the differential type, they can be dissociated, which allows much greater freedom in defining the trajectory of the flexible display hand and in choosing its shape and length.

Thus, thanks to the dissociation of the rotational drive and shape and length change functions of the flexible display hand, the actuating mechanism according to the invention makes it possible, in a remarkable way, to display two separate items of information using a single flexible display hand. More specifically, like any differential-type mechanism, the first differential mechanism of the actuating mechanism according to the invention comprises two inputs and one output, a first input receiving an angular rotation applied by the horological movement which ensures the rotation of the flexible display hand about itself, the second input receiving the control command for the change in length of the flexible display hand, and the output ensuring the driving thereof.

With regard to the second differential mechanism of the actuating mechanism according to the invention, one of its inputs receives, via a gear ratio, the angular rotation applied to the first differential mechanism by the horological movement, its second input receives a phase-shifting angular rotation applied by the horological movement, which determines the change in length of the flexible display hand, and its output applies the command for changing the length of the flexible display hand to the hand and to the second input of the first differential mechanism.

The actuating mechanism thus comprises two mutually independent inputs, one controlling the rotation of the flexible display hand, while the other controls the length thereof. Thus, by way of a non-limiting example only, the rotation of the flexible display hand can be used to display the current time, whereas the change in length can be programmed to occur when an alarm sounds.

This can be achieved by connecting the second input of the actuating mechanism, which controls the length of the flexible display hand, to an alarm wheel set, such as the regulator.

In particular embodiments, the invention can further include one or more of the following features, which must be considered singly or according to any combination technically possible.

In particular embodiments, the first differential mechanism is centred about a first axis of rotation D1 and is carried by a first planet carrier to which the horological movement is intended to apply the angular rotation.

This first planet carrier forms the first input of the first differential mechanism.

In particular embodiments, the first differential mechanism comprises a first sun pinion forming a first cannon-pinion intended to carry the first drive pipe, and a first sun wheel set mounted to rotate freely and coaxially with the first sun pinion. The first sun wheel set comprises a second sun pinion and a first sun wheel, the second sun pinion forming a second cannon-pinion intended to carry the second drive pipe.

The first sun pinion and the second sun pinion form the output of the first differential mechanism.

In particular embodiments, the first sun pinion is arranged such that it meshes with a first intermediate wheel, the latter meshing with a second intermediate wheel, itself meshing with the second sun pinion, the first and second intermediate wheels being arranged eccentrically on the first planet carrier.

In particular embodiments, the second differential mechanism is centred about a second axis of rotation D2, and is carried by a second planet carrier which is rotated by the first planet carrier in a gear ratio.

The second planet carrier constitutes the first input of the second differential mechanism.

In particular embodiments, the second differential mechanism comprises a second sun wheel set formed by a third sun pinion and a second sun wheel, the latter being engaged with the first sun wheel of the first differential mechanism.

Said second sun wheel forms the output of the second differential mechanism and said first sun wheel forms the second input of the first differential mechanism.

In particular embodiments, the second differential mechanism comprises a differential ring gear centred about the third sun pinion, this differential ring gear being provided with an inner toothing and cooperating with a profile of a cam, the second differential mechanism further comprising at least one planet pinion rolling on the inner toothing and meshing with the third sun pinion.

The cam constitutes the second input of the second differential mechanism.

In particular embodiments, the second differential mechanism comprises a rack provided with a toothed sector via which it engages with an outer toothing of the differential ring gear, at its other end opposite the toothed sector, the rack carrying a cam follower finger via which it bears against the profile of the cam.

In particular embodiments, the rotating cam is capable of being driven in an angular rotation of angle 02 determining the length of the flexible display hand, the rotation of the rotating cam causing, by means of the rack, the differential ring gear to pivot, and by means of a kinematic chain formed by the planet pinion, the second sun wheel set, the first sun wheel set and the first and second intermediate wheels, an antagonistic rotational motion of the first and second sun pinions relative to each other.

In particular embodiments, the actuating mechanism comprises a control member capable of being actuated by a user and capable of changing the angular position of the cam as a result of being operated, in order to change the length of the flexible display hand.

In particular embodiments, the differential ring gear is provided with a cam follower finger via which it bears against the profile of the cam.

### BRIEF DESCRIPTION OF THE FIGURES

Other features and advantages of the present invention will become apparent from the detailed description below of an embodiment of a mechanism for actuating a flexible display hand according to the invention, this example being given purely by way of illustration and without any limitation with reference to the accompanying drawing in which:

FIG. 1 diagrammatically shows a cross-sectional view of an embodiment of a mechanism for actuating a flexible display hand in accordance with the present invention;

FIG. 2 diagrammatically shows a perspective view, in the disassembled state, of the actuating mechanism according to the invention illustrated in FIG. 1; FIG. 3 diagrammatically shows a top view, in the unmounted state, of a flexible display hand intended to be driven by the actuating mechanism according to the invention;

FIG. 4 diagrammatically shows, in one particular embodiment of the invention, the actuating mechanism of FIG. 2, in which the differential ring gear is provided with a cam follower finger via which it bears against the profile of the cam.

### DETAILED DESCRIPTION OF THE INVENTION

The present invention was drawn from the general inventive idea consisting of providing an actuating mechanism for a flexible display hand of a watch, which actuating mechanism comprises a first and a second differential mechanism designated by the reference numerals 2 and 4 respectively.

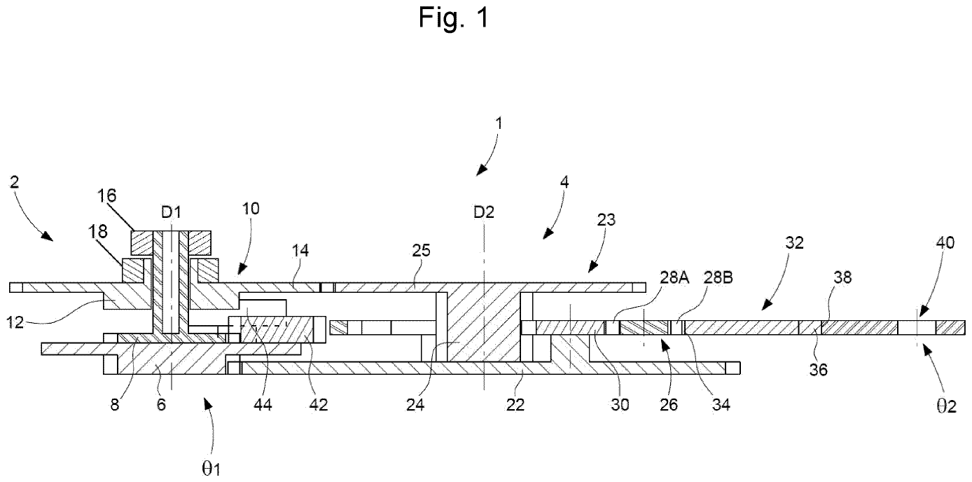

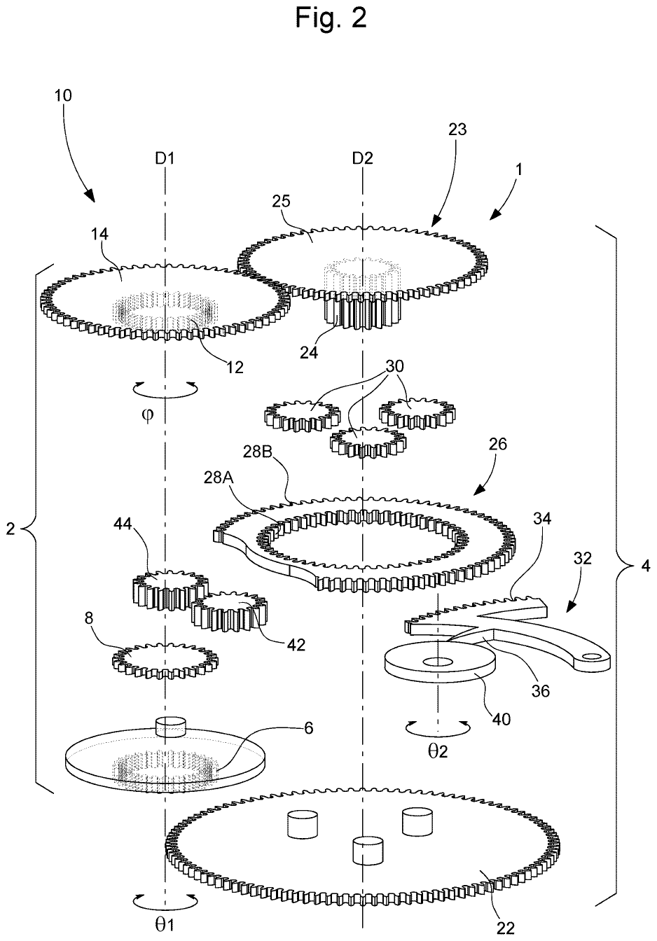

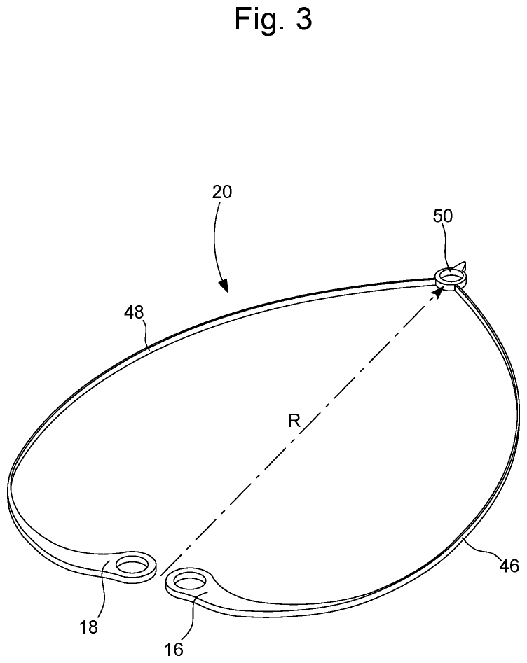

One embodiment of the actuating mechanism in accordance with the invention is illustrated in FIGS. 1 and 2.

Referred to as a whole by the general reference numeral 20, the flexible display hand capable of being driven by an actuating mechanism 1 in accordance with the invention is illustrated in its entirety in FIG. 3 and partially in FIG. 1. This flexible display hand 20 comprises a first drive pipe 16 arranged at a first end of a first flexible arm 46, and a second drive pipe 18 arranged at a first end of a second flexible arm 48. At their second end, the first and second flexible arms 46 and 48 are connected to one another by a tip 50.

In FIG. 3, the flexible display hand 20 is shown in an unstressed, free state, with the first and second drive pipes 16, 18 being spaced apart.

However, when in the operating position, the flexible display hand 20 is in a stressed state in which it is resiliently deformed and in which the first drive pipe 16 and the second drive pipe 18 are arranged coaxially as shown diagrammatically in FIG. 1. In this stressed position, the first drive pipe 16 is mounted with a first defined prestressing angle, and the second drive pipe 18 is mounted with a second defined prestressing angle in the opposite direction to that of the first drive pipe 16.

The first differential mechanism 2 is intended to receive an angular rotation applied by a horological movement, so as to ensure the rotation of the flexible display hand about itself. The second differential mechanism 4 is kinematically connected to the first differential mechanism 2 with a gear ratio and is intended to receive a phase-shifting angular rotation applied by the horological movement or by the user, for example by actuating a push-button. The phase-shifting angular rotation determines a change in length of the flexible display hand 20.

Thus, the mechanism for actuating the flexible display hand 20 according to the invention comprises two inputs which are independent of each other, one being intended to cause the flexible display hand 20 to rotate and the other being intended to cause its length to change. Thanks to this feature, the function of rotating the hand is dissociated from the function of changing its shape and length, which in particular allows manufacturers great freedom in determining the trajectory of the hand.

The first differential mechanism 2, centred about a first axis of rotation D1, is carried by a first planet carrier 6 to which a horological movement applies an angular rotation of angle θ1. This first differential mechanism 2 comprises a first sun pinion 8 arranged centred about the planet carrier 6 and free to rotate relative thereto. The first differential mechanism 2 further comprises a first sun wheel set 10 mounted to rotate freely and coaxially with the first sun pinion 8. This first sun wheel 10 comprises a second sun pinion 12 and a first sun wheel 14 fixedly mounted on the second sun pinion 12.

The first and the second sun pinion 8 and 12 are kinematically connected to each other by a first and second intermediate wheels 42 and 44, which are mounted eccentrically and free to rotate on the first planet carrier 6. In particular, as shown in FIGS. 1 and 2, the first sun pinion 8 meshes with the first intermediate wheel 42, the latter meshing with the second intermediate wheel 44, which itself meshes with the second sun pinion 12.

As described in detail below and as can be seen in FIG. 1, the first sun pinion 8 acts as the first cannon-pinion and the second sun pinion 12 acts as the second cannon-pinion, respectively for the first and second drive pipes 16 and 18 of a flexible display hand 20.

The flexible display hand 20 is thus arranged to change angular position when the first and the second sun pinion 8 and 12 are rotated by the horological movement.

It is also understood that the flexible display hand 20 is able to change shape and length when the angular position of the second sun pinion 12, corresponding to that of the second drive pipe 18, varies relative to the angular position of the first sun pinion 8, corresponding to that of the first drive pipe 16, by pivoting about the axis of rotation D1.

The second differential mechanism 4, centred about a second axis of rotation D2, is carried by a second planet carrier 22 which is driven by the first planet carrier 6. This second differential mechanism 4 comprises a second sun wheel set 23 formed by a third sun pinion 24 and a second sun wheel 25 which is engaged with the first sun wheel 14 of the first differential mechanism 2. This second differential mechanism 4 further comprises a differential ring gear 26 centred about the third sun pinion 24. This differential ring gear 26 has an inner toothing 28A and an outer toothing 28B.

At least one planet pinion 30 (three planet pinions spaced 120° apart in the example shown) rolls on the inner toothing 28A of the differential ring gear 26 and meshes with the third sun pinion 24. The second differential mechanism 4 further comprises a rack 32 provided with a toothed sector 34 via which it is engaged with the outer toothing 28B of the differential ring gear 26. At its other end, opposite the toothed sector 34, the rack 32 carries a cam follower finger 36 via which it follows a profile 38 of a rotating cam 40.

As already mentioned above, the energy necessary for the operation of the actuating mechanism 1 according to the invention is supplied thereto by a horological movement which applies an angular rotation 01 to the first planet carrier 6 of the first differential mechanism 2. Thus, driven by the horological movement, the first planet carrier 6 in turn drives the first differential mechanism 2 rotatably about itself about the axis of rotation D1. More specifically, the first planet carrier 6 drives the first and second sun pinion 8 and 12 rotatably about the axis of rotation D1 via the rotation of the first and second intermediate wheels 42 and 44 about said axis of rotation D1.

It is thus understood that the rotation of the first planet carrier 6 ensures the angular displacement of the flexible display hand 20.

Moreover, rotation of the first planet carrier 6 causes the second planet carrier 22 to rotate about the axis of rotation D2. As it rotates, the second planet carrier 22 drives the one or more planet pinions 30 rotatably. These planet pinions 30 roll on the inner toothing 28A of the differential ring gear 26 and in turn rotate, via the third sun pinion 24, the second sun wheel 25 which is engaged with the first sun wheel 14 of the first differential mechanism 2. The rotation of the second sun pinion 12 about the axis of rotation D1 is thus also caused by the rotation of the second sun wheel 25 about the axis of rotation D2.

Simultaneously, the horological movement can apply an angular rotation of angle θ2 to the rotating cam 40 so as to modify the length of the flexible display hand 20. More specifically, by rotating, the rotating cam 40 causes the rack 32 to pivot which, by pivoting the differential ring gear 26, transmits, through the kinematic chain formed by the planet pinions 30, the second sun wheel set 23, the first sun wheel set 10, the first and second intermediate wheels 42 and 44, and the first sun pinion 8, an antagonistic rotational motion of the first and second sun pinion 8 and 12 relative to each other. This antagonistic rotational motion corresponds to the phase-shifting angular rotation and allows the relative angular position of the drive pipes 16 and 18 of the flexible display hand 20 to be changed relative to each other, and thus the length of the flexible display hand 20 to be adjusted.

It should be noted that the antagonistic rotational motion of the first and second sun pinion 8 and 12 in relation to each other is caused in particular by the first and second intermediate wheels 42 and 44.

As described above, the first differential mechanism 2 ensures rotation of the flexible display hand 20, without any change in length. By way of illustration, if the rotating cam 40 were stationary (in other words, θ2=0), the first sun pinion 8 and the first sun wheel set 10 would rotate at the same speed and in the same direction because the gear ratio is calculated so that, in this case, the speed of the first planet carrier 6, which is equal to that of the first sun pinion 8, is equal to the speed of the first sun wheel set 10. As the first and the second sun pinion 8 and 12 act respectively as the first and second cannon-pinions on which the first and second drive pipes 16 and 18 are fastened, in this scenario the flexible display hand 20 is driven rotatably about the axis of rotation D1 while maintaining its length.

The second differential mechanism 4 ensures the change in length of the flexible display hand 20, without the rotation thereof. By way of illustration, if the first planet carrier 6 were stationary (in other words, θ1=0), the first sun pinion 8 and the first sun wheel 10 would rotate at the same speed but in opposite directions to each other, corresponding to an angular phase shift between the first and second sun pinion 8 and 12 due to the antagonistic rotation described hereinabove.

It should be noted that there can be no locking situation between the first differential mechanism 2 and the second differential mechanism 4 because the actuating mechanism 1 as a whole is arranged so that the first sun wheel 14 and the second sun wheel 25 rotate at the same tooth frequency when the rotating cam 40 is stationary (in other words, θ2=0).

It goes without saying that the present invention is not limited to the embodiment described hereinabove and that various simple alternatives and modifications can be considered by a person skilled in the art without leaving the scope of the invention as defined by the accompanying claims.

In particular, the term “length of the flexible display hand 20” is understood to mean the radius R which passes between the two drive pipes 16, 18 and through the tip 50 of this flexible display hand 20. It should also be noted that, in the event that the rotating cam 40 is not driven by the horological movement, a control member can be considered, for example a push-button that can be actuated by the user from outside the watch case, in order to change the angular position of the cam and thus modify the length of the flexible display hand 20.

More specifically, by moving the cam from a first position to a second position that is different from the first, the phase shift between the flexible arms 46, 48 of the flexible display hand 20 can be changed, and thus the length thereof can also be changed.

Subsequently, as the position of the cam remains unchanged, the flexible display hand 20 will only rotate about itself, without changing length. By modifying the length of the flexible display hand 20, it is thus possible, for example, to bring the tip 50 of this flexible display hand 20 to face either one of two separate graduations, and thus to display the values of two different parameters.

Thus, for example, the angle that the flexible display hand 20 forms with its initial position can be used to provide an indication of the current time, while the length and/or shape of the flexible display hand 20 will provide the user with an indication of the watch's power reserve.

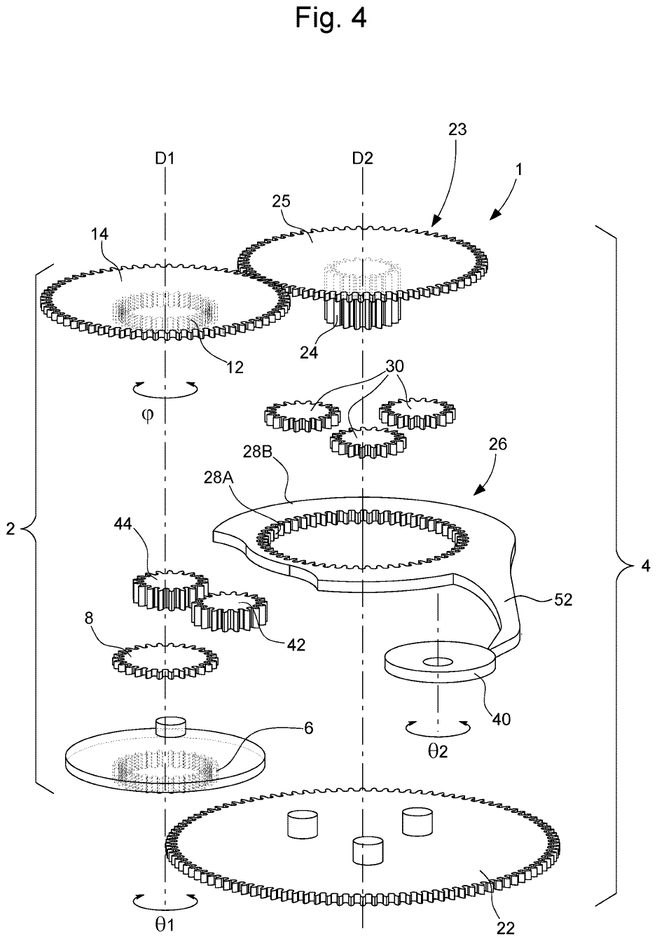

FIG. 4 illustrates a particular embodiment of the invention wherein the differential ring gear 26 is provided, on its outer perimeter which, in this case, has no toothing, with a cam follower finger 52 via which it bears against the profile 38 of the cam 40.

1-11. (canceled)

12. An actuating mechanism (1) for actuating a flexible display hand (20), intended to be driven by a horological movement of a watch, the flexible display hand (20) comprising a first drive pipe (16) connected to a first end of a first flexible arm (46), and a second drive pipe (18) connected to a first end of a second flexible arm (48), the first and second flexible arms (46, 48) being connected together at their second end by a tip (50), the flexible display hand (20) being in an operating position in which it is in a stressed state and has a defined shape and length, the first and the second drive pipe (16, 18) being arranged coaxially about an axis of rotation D1, the actuating mechanism (1) comprising:
a first differential mechanism (2) comprising a first input intended to receive an angular rotation of angle (θ1) about the axis of rotation D1, transmitted by the horological movement, and an output of the first differential mechanism (2) configured to drive the flexible display hand (20) rotatably;
a second differential mechanism (4) comprising a first input kinematically connected to the first input of the first differential mechanism (2) with a gear ratio, a second input intended to receive an angular rotation (θ2), and an output configured to drive the change in length of the flexible display hand (20), said output being kinematically connected to a second input of the first differential mechanism (2).

13. The actuating mechanism (1) according to claim 12, wherein the first differential mechanism (2) is centred about a first axis of rotation D1 and is carried by a first planet carrier (6) to which the horological movement is intended to apply the angular rotation of angle (θ1).

14. The actuating mechanism (1) according to claim 13, wherein the first differential mechanism (2) comprises a first sun pinion (8) forming a first cannon-pinion intended to carry the first drive pipe (16), and a first sun wheel set (10) mounted to rotate freely and coaxially with the first sun pinion (8), the first sun wheel set (10) comprising a second sun pinion (12) and a first sun wheel (14), the second sun pinion (12) forming a second cannon-pinion intended to carry the second drive pipe (18).

15. The actuating mechanism (1) according to claim 14, wherein the first sun pinion (8) is arranged such that it meshes with a first intermediate wheel (42), the latter meshing with a second intermediate wheel (44), itself meshing with the second sun pinion (12), the first and second intermediate wheels (42, 44) being arranged eccentrically on the first planet carrier (6).

16. The actuating mechanism (1) according to claim 13, wherein the second differential mechanism (4) is centred about a second axis of rotation D2, and is carried by a second planet carrier (22) which is rotated by the first planet carrier (6) in a gear ratio.

17. The actuating mechanism (1) according to claim 16, wherein the second differential mechanism (4) comprises a second sun wheel set (23) formed by a third sun pinion (24) and a second sun wheel (25) which is engaged with the first sun wheel (14) of the first differential mechanism (2).

18. The actuating mechanism (1) according to claim 17, wherein the second differential mechanism (4) comprises a differential ring gear (26) centred about the third sun pinion (24), this differential ring gear (26) being provided with an inner toothing (28A) and cooperating with a profile (38) of a cam (40), the second differential mechanism (4) further comprising at least one planet pinion (30) rolling on the inner toothing (28A) and meshing with the third sun pinion (24).

19. The actuating mechanism (1) according to claim 18, wherein the second differential mechanism (4) comprises a rack (32) provided with a toothed sector (34) via which it engages with an outer toothing (28B) of the differential ring gear (26), at its other end opposite the toothed sector (34), the rack (32) carrying a cam follower finger (36) via which it bears against the profile (38) of the cam (40).

20. The actuating mechanism (1) according to claim 15, wherein the rotating cam (40) is capable of being driven in an angular rotation of angle (θ2) determining the length of the flexible display hand (20), the rotation of the rotating cam (40) causing, by means of the rack (32), the differential ring gear (26) to pivot, and by means of a kinematic chain formed by the planet pinion (30), the second sun wheel set (23), the first sun wheel set (10) and the first and second intermediate wheels (42, 44), an antagonistic rotational motion of the first and second sun pinion (8, 12) relative to each other.

21. The actuating mechanism (1) according to claim 20, further comprising a control member capable of being actuated by a user and capable of changing the angular position of the cam (40) as a result of being operated, in order to change the length of the flexible display hand (20).

22. The actuating mechanism (1) according to claim 18, wherein the differential ring gear (26) is provided with a cam follower finger (52) via which it bears against the profile (38) of the cam (40).
